(19) United States
(12) Patent Application Publication
(10) Pub. No.: US 2013/0238619 A1
(43) Pub. Date: Sep. 12, 2013

(54) DATA PROCESSING SYSTEM, AND DATA PROCESSING DEVICE

(71) Applicants: Miyuki Hanaoka, Fuchu (JP); Itaru Nishizawa, Koganei (JP); Keiro Muro, Koganei (JP)

(72) Inventors: Miyuki Hanaoka, Fuchu (JP); Itaru Nishizawa, Koganei (JP); Keiro Muro, Koganei (JP)

(21) Appl. No.: 13/822,112

(22) PCT Filed: Feb. 17, 2011
(86) PCT No.: PCT/JP2011/053424

§ 371 Date: Mar. 27, 2013

(30) Foreign Application Priority Data
Dec. 3, 2010 (JP) 2010-269878

(51) Int. Cl. G06F 17/30

(52) U.S. Cl. CPC G06F 17/30424
USPC 707/736; 707/769

(57) ABSTRACT

The present invention provides a data processing system and a data processing device with which a search for data having a desired time-series data pattern is carried out quickly from among a large amount of stored time-series data. The data processing device generates feature information which indicates the features of received data, associates the feature information with said data which is held in a connected storage device and records the feature information in the storage device, and carries out a search in relation to the data held in the storage device, based on the feature information held in the storage device. Furthermore, the data processing device generates new feature information based on multiple items of said feature information.

### TECHNICAL FIELD

The present invention relates to a data processing method, a data processing system carrying out the method, and a data processing device. Particularly, the present invention relates to a technology of carrying out data processing using a time-series pattern of time-series data that is data generated over time.

### BACKGROUND ART

With the development of sensing technologies, such as radio frequency identification (RFID), a global positioning system (GPS), and the like, various sensor data can be acquired from a real world, such as a factory, an office, and the like, and thus an example of using the acquired data in industries is being increased. For example, an application example, such as instrument preventive maintenance, and the like, of acquiring operating information, such as revolutions per minute (RPM) or pressure of a motor, from plant instruments or facilities, and the like, in a factory, and the like, and previously detecting an abnormality or a failure of instrument based on the value or change of the acquired information, has been put to practical use.

In order to use the sensor data, there is a need to understand the operation characteristics thereof by analyzing data. The sensor data is characterized by so-called time-series data generated over time and in order to understand the operation characteristics thereof, it is important to search for a change in a data pattern over time. As a result, the sensor data may be used in industries, by using features and tendency of instruments or facilities acquired from a sensor device.

For the analysis of the time-series data, a method for accumulating data and searching various time-series data patterns for the accumulated data in a trial and error manner is adopted. The search of the time-series data will be described in detail herein with reference to an abnormality diagnosis of plant instruments in a factory as an example. Recently, an example of monitoring facilities or carrying out preventive maintenance using sensors attached to instruments in plant industries is being increased. As an example, an example of carrying out abnormality diagnosis using a temperature sensor attached to an engine may be considered. Sensor data acquired from the temperature sensor every time are frequently accumulated in a storage device, such as a hard disk, and the like.

For an abnormality diagnosis of plant instruments in a factory, an administrator monitors time-series data to acquired from a sensor, such that when any abnormality occurs, there are some cases where it is necessary to early cope with the abnormality based on the previously accumulated time-series data. In this case, it is required to quickly query a large amount of sensor data. Examples of a method for quickly querying the sensor data may include a method for dividing time-series data at a specific time width and allocating an integrated feature quantity, such as an average value, and the like, to each section, as disclosed in Non-Patent Literature 1.

For example, in an example of the temperature sensor, when the integrated feature quantity is used to query the time when temperature is 1000° C. or more, a section in which a maximum value is less than 1000° C. can be removed from a query object without accessing original time-series data, such that a high-speed query can be implemented. Non-Patent Literature 1 discloses a method for implementing a high-speed query by querying the sensor data based on an alphabet without accessing the original sensor data, by calculating an average value for each section and allocating the alphabet corresponding to the average value.

Further, Patent Literature 1 discloses a method for carrying out labeling using the integrated feature quantities for each section and finding regularity between labels.

### CITATION LIST

### Patent Literature

Patent Literature 1: Japanese Patent Application Laid-Open Publication No. 2006-338373

### Non-Patent Literature

Non-Patent Literature 1: “Implementation of Index for High-Speed Query to Sensor Data” by Nakajima Saki, in pp 67-68 of Summary of Presentation of 17th Graduation, Information Science, Science Faculty, Ochanomizu Women's University

### SUMMARY OF INVENTION

### Technical Problem

As described above, for abnormality diagnosis of plant instruments, and the like, in a factor, an administrator searches for a similar time-series data pattern, i.e., a similar time-series pattern, from previously accumulated time-series data when the administrator observes an abnormal time-series data pattern different from usual, thereby helping in establishing early measures for the abnormality of the similar time-series pattern. For the search of the time-series data in addition to the similar time-series pattern, for example, sensor values of each sensor data, such as revolutions per minute, a temperature, pressure, and the like, of a motor at some point are important, but a progress of the sensor values (time-series pattern) derived from the data series is more important. Therefore, for the search, it is more important to taking out the data series matched with a specific search pattern than taking out data matched with conditions for each sensor value one by one.

When searching the similar time-series pattern for the accumulated time-series data using the related art as described above, it is difficult to sufficiently narrow the section having the similar time-series pattern only by the integrated feature quantity, such as the average value, and the like, used in Non-Patent Literature 1. In the integrated feature quantity, the data within the section is indicated by one representative value, such that the time-series pattern within the section cannot be indicated. As a simple example, the time-series pattern of monotone increase and the time-series pattern of monotone decrease, which have the same maximum and minimum values, are considered. In this case, since all of the maximum value, the minimum value, and the average value within the section have the same value, both sections are searched as the section having the similar time-series pattern in the integrated feature quantity even at the time of searching only the pattern of the monotone increasing. As such, when the section is not sufficiently narrow, unnecessary (non-similar) data are searched, and thus there is a problem in that search performance may deteriorate.

Further, the technology disclosed in Patent Literature 1 founds the regularity such as a combination of classification labels easily expressed simultaneously, an order of classification labels easily expressed, and the like, in a single sensor or between a plurality of sensors, but indicates only the regularity. That is, the found regularity is maintained but is not used for the search of the time-series pattern, and therefore there is a problem in that it is possible to realize the high-speed search for the time-series data by using the regularity between the labels.

### Solution to Problem

As one aspect of the present invention to address at least one of the problems, a data processing device according to the present invention generates feature information that is information indicating features of received data and associates the feature information with the data which is held in a connected storage device and records the feature information in the storage device.

Further, as one aspect of the present invention to address at least one of the problems, the data processing device according to the present invention carries out a search in relation to the data held in the storage device, based on the feature information held in the storage device.

In addition, as one aspect of the present invention to address at least one of the problems, the data is data generated over time and the feature information indicates features for the progress of the data.

Furthermore, as one aspect of the present invention to address at least one of the problems, the data processing device extracts multiple items of feature information held in the storage device and generate new feature information based on the multiple items of extracted feature information.

### Advantageous Effects of Invention

According to one aspect of the present invention, it is possible to quickly carry out a search for data having a desired data pattern from accumulated data.

### BRIEF DESCRIPTION OF DRAWINGS

FIG. 1 is a block diagram illustrating a simple system configuration of one embodiment of a time-series data processing system to which the present invention is applied.

FIG. 2 is a conceptual diagram illustrating an example of the time-series data.

FIG. 3 is a diagram illustrating an example of a time-series data table.

FIG. 4 is a diagram illustrating an example of a feature quantity table.

FIG. 5 is a diagram illustrating an example of a feature quantity calculation method table.

FIG. 6 is a block diagram illustrating a first example of a configuration of a time-series data accumulation program and a time-series data search program and a data flow.

FIG. 7 is a flow chart illustrating processing of a time-series writing unit.

FIG. 8 is a flow chart illustrating processing of a feature quantity writing unit.

FIG. 9 is a diagram illustrating an example of allocating a label as a feature quantity to the time-series data.

FIG. 10 is a diagram illustrating an example of allocating a label and then varying a section length of a feature quantity based on the label.

FIG. 11 is a diagram illustrating an example of the time-series data and a label of the feature quantity.

FIG. 12 is a block diagram illustrating a second example of a configuration of a time-series data accumulation program and a time-series data search program and a data flow.

FIG. 13 is a flow chart illustrating processing of a feature quantity adding unit by the feature quantity calculation method.

FIG. 14 is a flow chart illustrating processing of the feature quantity adding unit by a finding of regularity.

FIG. 15 is a flow chart illustrating processing of the feature quantity adding unit by a non-similarity determination.

FIG. 16 is a diagram illustrating an example of adding the feature quantity by the finding of regularity.

FIG. 17 is a diagram illustrating an example of adding the feature quantity by the non-similarity determination.

FIG. 18 is a flow chart illustrating processing of the time-series data search program.

FIG. 19 is a diagram illustrating a first example of a search query.

FIG. 20 is a diagram illustrating an example of search conditions designated as a where_condition phrase during the search query.

FIG. 21 is a flow chart of feature quantity search processing when a label designation search is given as the search conditions.

FIG. 22 is a flow chart of the feature quantity search processing when a time designation similar search is given as the search conditions.

FIG. 23 is a flow chart of feature quantity search processing when a non-similar search is given as the search conditions.

FIG. 24 is a diagram illustrating an example of a search concept.

FIG. 25 is a diagram illustrating an outline of a system in one embodiment of a time-series data network system to which the present invention is applied.

FIG. 26 is a diagram illustrating an example of a feature quantity table having a sensor ID or multiple values of a feature quantity.

FIG. 27 is a diagram illustrating an example of the feature quantity calculation method table.

FIG. 28 is a flow chart illustrating processing of the feature quantity calculation method 3.

FIG. 29 is a diagram illustrating an appearance in which the input time-series data is read in a buffer.

FIG. 30 is a diagram illustrating a second example of a search query.

FIG. 31 is a diagram illustrating an example of a result display screen of the search query at the time of the search by the label.

FIG. 32 is a diagram illustrating an example of a feature quantity table updating command input from a user.

FIG. 33 is a flow chart illustrating the feature quantity updating processing example.

### DESCRIPTION OF EMBODIMENTS

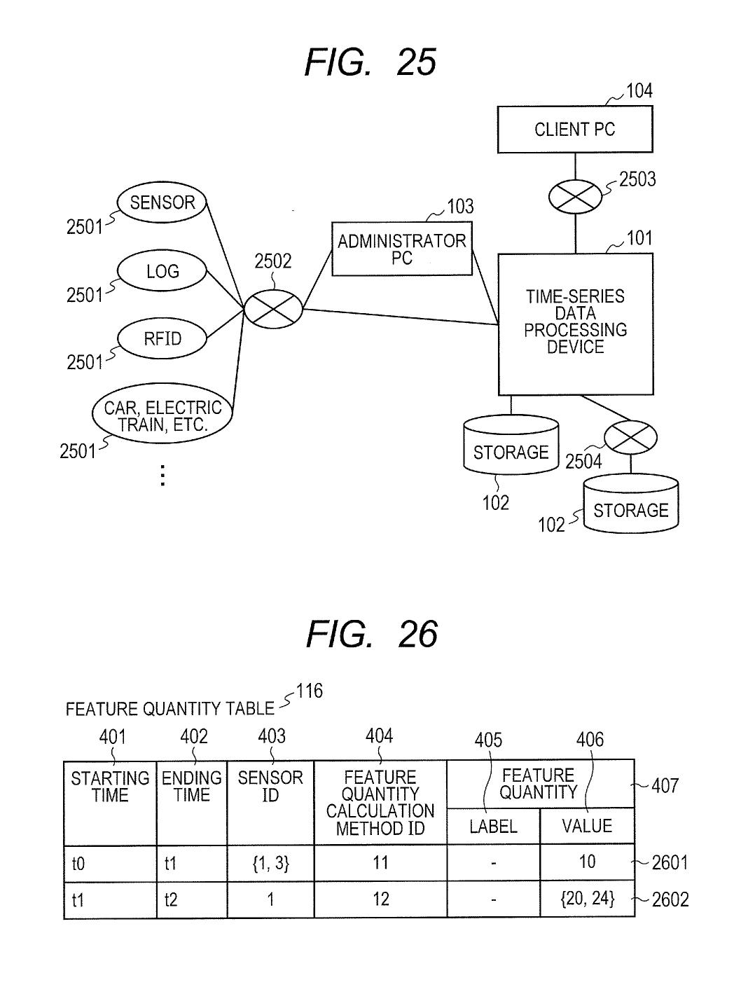

FIG. 25 is a block diagram illustrating an outline of a system in one embodiment of a time-series data network system to which the present invention is applied. The time-series data network system includes a data generation device 2501 such as a sensor, and the like, a time-series data processing device 101, a storage device 102, an administrator PC 103, and a client PC 104 that is a terminal used by a user, all of which are connected with each other through networks 2502, 2503, and 2504. As the network, for example, a dedicated line, a wide area network, such as a so-called Internet, a local network, such as LAN, and the like, may be used.

The data generation device 2501 means a device generating data over time. An example of the data generation device 2501 may include sensors attached to facilities or instruments of a plant, a log or performance data (CPU or memory using rate, and the like) of a server within a data center, RFID, a vehicle sensor such as a car, a train, and the like, but is not limited thereto. The time-series data generated from the data generation device 2501 is input to the time-series data processing device 101 via a network. Further, the time-series data may be input to the administrator PC 103 once, accumulated in the administrator PC 103 by a predetermined amount, and then input to the time-series data processing device 101. The time-series data processing device 101 processes the input time-series data, which is in turn held in the storage device 102 as a data. The storage device 102 may be directly connected with the time-series data processing device 101 and may also be connected therewith via the network. The client PC acquires a data, and the like, generated from the data generation device 2501 via, for example, the networks 2502 and 2503 and carries out a request of a search in relation to the data generated from the data generation device 2501 via the network 2503.

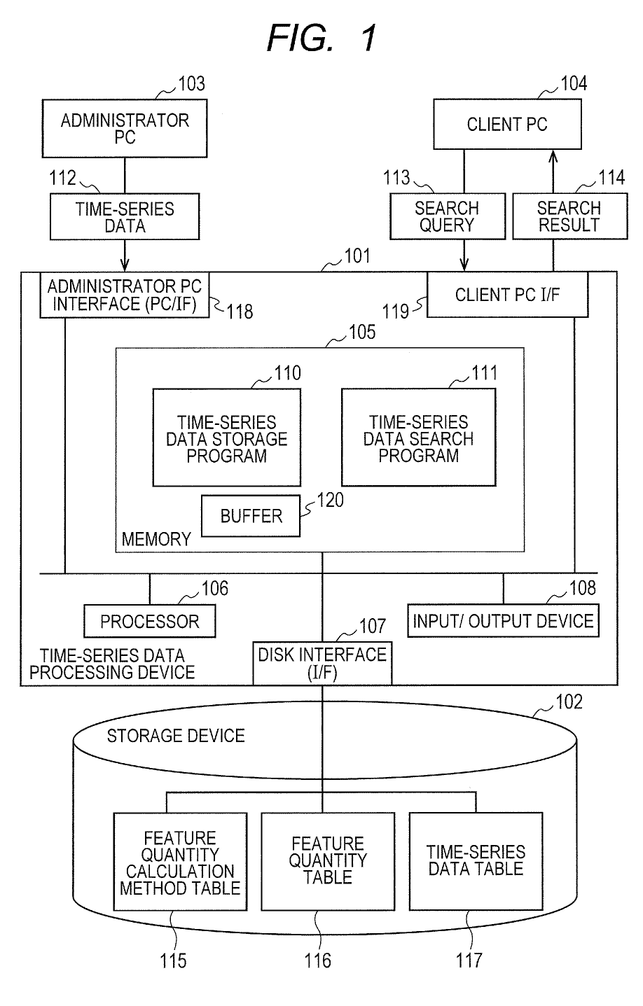

FIG. 1 is a block diagram illustrating in more detail one embodiment of the time-series data network system illustrated in FIG. 25, particularly, a configuration of the time-series data processing device 101 and the storage device 102. Further, the time-series data used in the embodiment means a data continuously or discontinuously generated over time. The time-series data processing system according to the embodiment includes the time-series data processing device 101, the storage device 102, the administrator personal computer (PC) 103, and the client PC 104.

The time-series data processing device 101 is a device carrying out the accumulation and search of the time-series data. The time-series data processing device includes a memory 105, a processor 106, a disk interface (I/F) 107, and an input/output device 108 that are interconnected, and is interconnected with the storage device 102 through the disk I/F 107. In addition, the time-series data processing device 101 is connected with the administrator PC 103 through an administrator PC I/F 118 and is connected with the client PC 104 through a client PC I/F 119.

The memory 105 is configured of a storage medium such as, for example, a random access memory (RAM). The input/output device 108 is configured of devices, such as, for example, a keyboard, a mouse, a liquid crystal monitor, and the like.

The memory 105 stores a time-series data accumulation program 110 that carries out the accumulation of a time-series data 112 and the calculation and accumulation of a feature quantity and a time-series data search program 111 that carries out the search for the time-series data based on a search query 113 input from the client PC and includes a buffer 120 that is a region in which the time-series data 112 can be temporarily stored. In the embodiment, each processing of the time-series data accumulation program 110 and the time-series data search program 111 to be described below is realized by allowing the processor 106 to carry out these programs stored in the memory 105. However, a part or all of these processings may also be realized by an integrated circuit or hardware.

The administrator PC 103 is a terminal of an operation administrator that carries out various settings for storing instruction or data management of the time-series data 112 on the time-series data processing device 101. The client PC 104 is a user terminal carrying out a search on the time-series data processing device 101 and transmits the search query 113 indicating a search request and receives a search result 114. The administrator PC 103 and the client PC 104 include a processor, a memory, an input/output device, and the like, that are not illustrated in the drawings. In addition, the administrator PC 103 and the client PC 104 may be the same.

The storage device 102 includes a time-series data table 117 that stores time-series data, a feature quantity table 116 that stores a feature quantity of time-series data, and a feature quantity calculation method table 115 that stores a feature quantity calculation method. Although the embodiment describes the storage device 102 as a storage device permanently holding data to be processed, any storage device, which is capable of permanently holding data, such as a semiconductor disk device using a flash memory, an optical disk device, and the like, as a storage medium, may be used as a storage device. Further, the tables 115 to 117 are described as, for example, a table of a relational database, but any method, which can be represented as a table, such as one to a plurality of files stored in a file system, a program for accessing these files, and the like, may be used as a table.

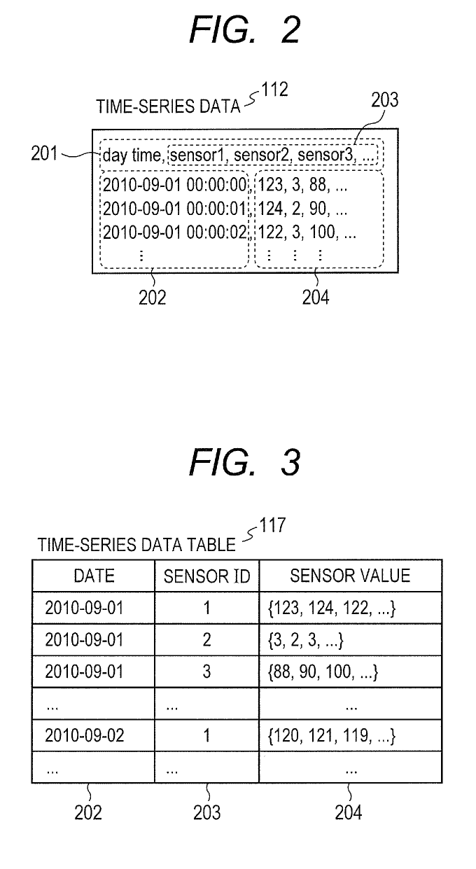

FIG. 2 is a diagram illustrating an example of the time-series data 112. The time-series data is configured of sensor values 204 (for example, operating information such as revolution per minute, pressure, and the like, or physical quantity such as temperature, humidity, and the like) that are measured values acquired from a sensing device or facilities and instruments, and the like, a sensor ID 203 indicating a sensor of a generation source, and a generation time 202 thereof. In FIG. 2, the time-series data represents the meaning of each column of a row read after a second row in a first row 201. Here, the generation time 202 of the sensor values and the sensor value 204 in the order of sensor 1, sensor 2, sensor 3, . . . , are input. In the example, the sensor value is acquired for each second (the generation time 202 is based on a second unit) and the sensor ID 203 is allocated with 1, 2, 3, . . . in sequence and is represented in a CSV format divided by a comma and a line feed. For example, a sensor value, which is acquired from a sensor ID 1 at 0:0:0 on Sep. 1, 2010, is 123. Further, in the embodiment, the time-series data 112 is described as various measurement data, but is not limited thereto so long as the data is data generated over time. As in the example, the time-series data is not necessarily generated periodically. For example, a stock data, and the like, may also be an object of the present invention.

FIG. 3 is a diagram illustrating an example of the time-series data table 117. The time-series data table 117 is a table for accumulating the time-series data 112 and is configured of the generation time 202 of the sensor data 201, the sensor ID 203, and the sensor value 204. The sensor values 204 of one or a plurality of sensor data 201 are collectively stored in one row. As the collection unit, a fixed value set by the administrator PC may be used. In the example of the drawings, the time-series data is divided for each day and the sensor values 204 of the divided temporal section are collectively stored. The value measured by the sensor of which the sensor ID 203 is 1 from 0:0:0 on Sep. 1, 2010 to 23:59:59 on the same date is stored in the first row. The configuration of the table is not limited to the example of the drawings, and therefore any configuration capable of storing the generation time 202, the sensor ID 203, and the sensor value 204 of the input time-series data 112 may be permitted. Further, it is possible to compress data at the time of storing. The data quantity is reduced by compressing the data, thereby reducing the storage cost.

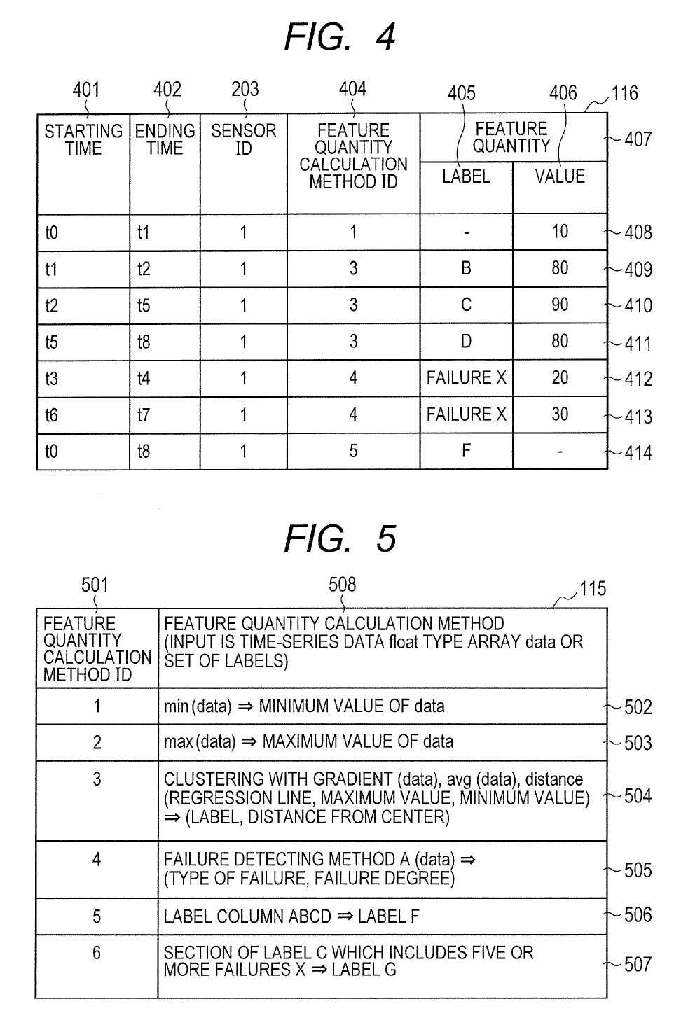

FIG. 4 is a diagram illustrating an example of the feature quantity table 116. The feature quantity table 116 is a table for storing a feature quantity to quickly carry out a search for the time-series data and includes a starting time 401, an ending time 402, the sensor ID 203, a feature quantity calculation method ID 404, and a feature quantity 407 in a section allocating each feature quantity. Since the feature quantity 407 is allocated to a temporal section independent from the temporal section in which the time-series data is stored in the time-series data table 117 and the section width thereof varies, the feature quantity 407 is designated by the starting time 401 and the ending time 402. The feature quantity calculation method ID 404 in the feature quantity table 116 designates a feature quantity calculation method ID 501 in the feature quantity calculation method table 115 to be described below. The feature quantity 407 is stored as the feature quantity obtained by applying the feature quantity calculation method designated by the feature quantity calculation method ID 404 to the time series data in the section from the starting time 401 to the ending time 402. The feature quantity 407 is configured of at least any one of a label 405 and a value 406. There are a feature quantity having only a label, a feature quantity having only a value, and a feature quantity having both the label and the value according to the feature quantity calculation method.

The feature quantity means information representing the feature of the time-series data of the specific section. One example of the feature quantity is an integrated feature quantity and is a maximum value, a minimum value, and an average value of the section. In the embodiment, the feature quantity is configured of the label and the value, but the integrated feature quantity like the maximum value is treated as the feature quantity having only the value. Further, as one example of using the label as the feature quantity, there is a label indicating the patterns of the time-series data. The same label is allocated as the feature quantity in the section in which the patterns of the time-series data are similar, by using a character, a numerical value, a symbol, and the like. The time-series data is a column of a value over time and the pattern (time-series pattern) of the time-series data means a change method of a value of a time-series data over time and the fact that the patterns of the time-series data are similar means that the change method of the value of the time-series data is similar.

As such, unlike the integrated feature quantity, the time-series data in any section is not integrated as one value, and the same label is added to the similar time-series data as the pattern. Further, as an example of using the combination of the label and the value as the feature quantity, there is the feature quantity using the label indicating the pattern and the similarity as the value. The similarity stated herein is a value indicating how much the time-series pattern of the section is similar to the time-series pattern in other sections to which the same label is added. The detailed example will be described. In addition, FIG. 4 illustrates, as one example of the feature quantity table 116, the feature quantity table for the sensor data of which the sensor ID 203 is 1 but the feature quantity 407 for the sensor data of the different sensor IDs may be stored in one feature quantity table.

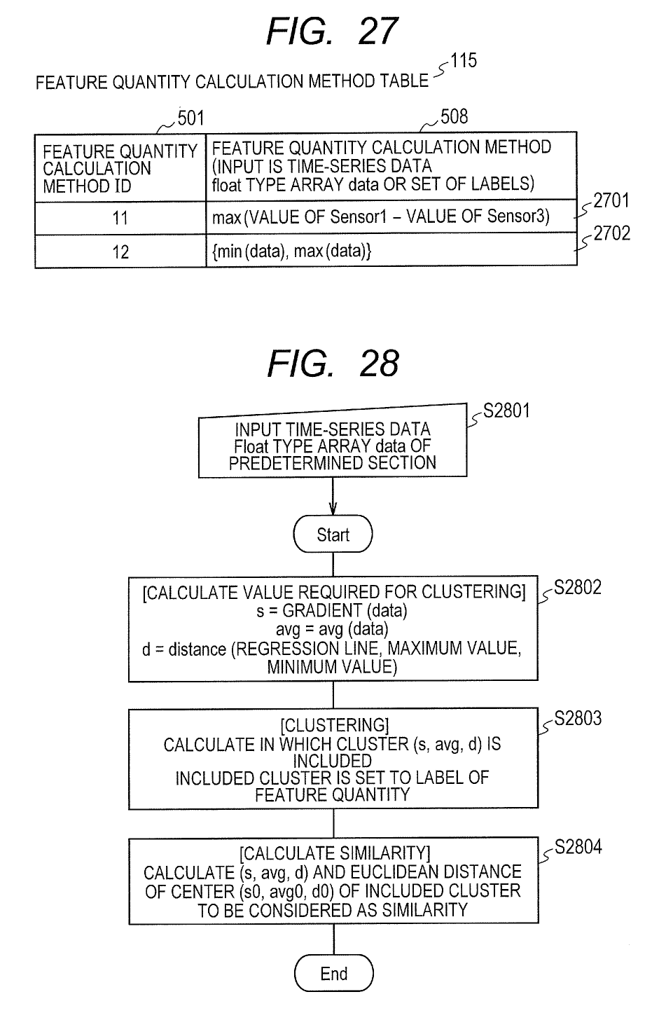

Further, as the modified example of the feature quantity table 116, the sensor ID 203 or the value 406 of the feature quantity may take multiple values. FIG. 26 illustrates the modified example of the feature quantity table and FIG. 27 illustrates the corresponding feature quantity calculation method table. As the example in which the sensor ID 203 is plural, a feature quantity calculation method using a difference between values of two sensors, and the like, may be considered. For example, if it is appreciated that when the values of the sensor 1 and the sensor 3 are normal, the values are substantially the same, a maximum value (2701 of FIG. 27) of the difference between the values of the sensor 1 and the sensor 3 is stored as the feature quantity (2601 of FIG. 26). Therefore, the search in relation to the plurality of sensors called an abnormal section in which the difference between the two sensors is large may be carried out quickly. In addition, a feature quantity calculation method using a vector value having multiple values as the value of the feature quantity may also be used. For example, a pair (2702 of FIG. 27) of the maximum value and the minimum value of the time-series data is stored as the feature quantity (2602 of FIG. 26). Therefore, the search in relation to the multiple values called the search for the section in which the difference between the maximum value and the minimum value is a predetermined value or more can be carried out quickly. Further, the size of the feature quantity table may be smaller than the case in which the maximum value and the minimum value are respectively stored as a separate feature quantity.

In the embodiment, the feature quantity 407 is stored in the one feature quantity table 116 by the multiple feature quantity calculation method IDs 404, and therefore there is no need to manage the table according to the change in the feature quantity calculation method, such that the feature quantity table can be easily managed. This is because even when the user or the system adds and deletes the feature quantity calculation method if necessary, there is no need to newly add and delete the feature quantity table corresponding to the feature quantity calculation method. However, it is possible to divide and write the feature quantity table 116 for each feature quantity calculation method.

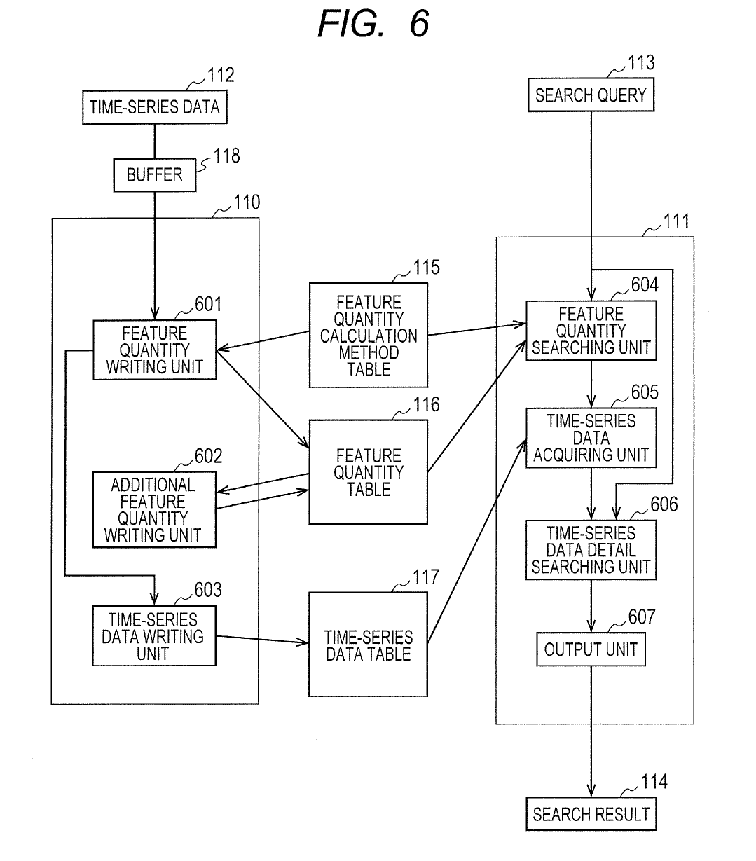

FIG. 5 is a diagram illustrating an example of the feature quantity calculation method table 115. The feature quantity calculation method table 115 is configured of a feature quantity calculation method ID 501 and a feature quantity calculation method 508. The feature quantity calculation method 508 includes a feature quantity calculation method (left of =>) for a set of the time-series data (an arrangement of values) or labels in any section and a feature quantity (right of =>) calculated accordingly. 1 to 4 of FIG. 5 illustrate a feature quantity calculation method for an arrangement data of a float type value or a feature quantity calculation method based on a relationship between the labels. For example, the feature quantity calculation methods 1 and 2 calculate a minimum value and a maximum value as a feature quantity, in the time-series data in the given section (502 and 503). In addition, like feature quantity calculation methods 5 and 6, there may be the feature quantity (right of =>) calculated by the relationship of the labels (right of =>), not the time-series data (506 and 507). Each feature quantity calculation method will be described below in detail. Further, for convenience of explanation, FIG. 5 illustrates the feature quantity calculation method 508 as a natural language, but the feature quantity calculation is carried out by fetching a program prepared in advance or individually defined by a user.

The feature quantity calculation method table 115 is set by the administrator PC 103 at the time of starting an operation. In addition, each feature quantity calculation method 508 is held in the feature quantity calculation method table 115 in the storage device as the program and the feature quantity calculation methods 508 are carried out by the processor 106 based on the time-series data accumulation program 110 to calculate the feature quantity 407. Further, during the operation, the user may review and verify and then change the feature quantity calculation method in a trial and error manner, while analyzing the time-series data. The feature quantity calculation method table is appropriately changed if necessary and the feature quantity table during the operation is written by adding or deleting the feature quantity calculation method. As a method for designating the feature quantity calculation method, in addition to a method individually written and designated by the user, in the system side, a general calculation method usable for any business, a method for preparing and designating a set of calculation methods specified for businesses and services in advance, and the like may be considered. Further, as described below, in addition to the feature quantity calculation method designated by the user, the time-series data processing system can add the feature quantity calculation method.

FIG. 6 is a block diagram illustrating a configuration of a functional block of the time-series data accumulation program 110 and the time-series data search program 111 and a data flow represented by an arrow. The time-series data accumulation program 110 is configured of a time-series writing unit 603 that writes the input time-series data 112 in the time-series data table 117, a feature quantity writing unit 601 that calculates the feature quantity for the input time-series data 112 based on the feature quantity calculation method table 115 and writes the calculated feature quantity in the feature quantity table 116, and an additional feature quantity writing unit 602 that calculates a new feature quantity based on the feature quantity stored in the feature quantity table 116 and adds the calculated feature quantity to the feature quantity table 116.

The time-series data search program 111 is configured of a feature quantity search unit 604 that specifies a section likely to match the input search query 113, among all the time-series data of the search object range by referring to the feature quantity table 116, a time-series data acquisition unit 605 that acquires the time-series data of the section specified by the feature quantity search unit 604 from the time-series data table 117, a time-series data detailed search unit 606 that searches in detail the acquired time-series data to acquire a portion matching the search query 113, and an output unit 607 that outputs results obtained by the detailed search as the search results.

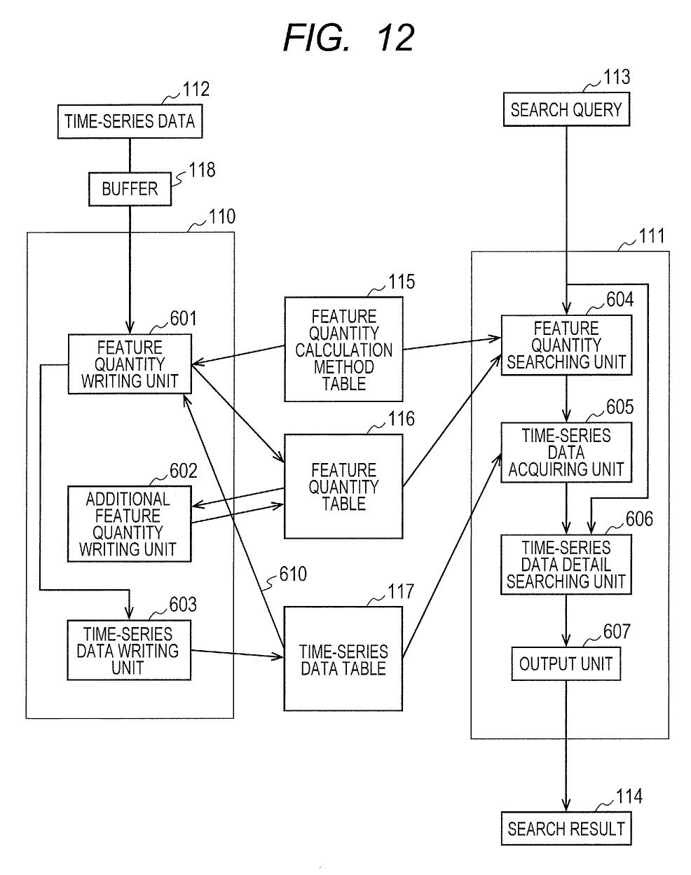

Here, the overall flow of the data accumulation by the time-series data accumulation program 110 and the data search by the time-series data search program 111 will be briefly described. The time-series data accumulation program 110 accumulates the time-series data 112 input from the administrator PC 103 in the time-series data table 117 (time-series writing unit 603). Further, at the same time, the feature quantity indicating the pattern of the time-series data, which is an index at the time of searching the time-series data, is calculated by using the input time-series data 112 and is stored in the feature quantity table 116 (feature quantity writing unit 601). Here, as illustrated in FIG. 12, the time-series writing unit 603 may first use the time-series data used by the feature quantity writing unit 601 by reading the data written in the time-series data table 117 (610). In this case, the time-series data can be read in a time width different from a division time width in the time-series data table 117. The additional feature quantity writing unit 602 adds a new feature quantity by referring to the feature quantity table. In the time-series data search program 111, when the search query 113 is given from the client PC 104, the feature quantity search unit 604 first uses the feature quantity table 116 to limit the section of the time-series data matching the search query 113 among the time-series data within the search object range. Next, the feature quantity search unit 604 acquires the limited time-series data to perform the detailed search using the time-series data (raw data) and output the final search result 114. The time-series data is limited using the feature quantity at the earliest stage of the search to reduce the quantity of time-series data performing the acquisition and the detailed search, such that the search processing can be carried out quickly. In addition, the description of contents of the search query 113 will be described below with reference to FIG. 20.

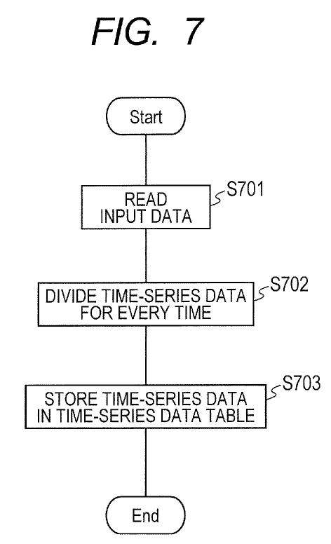

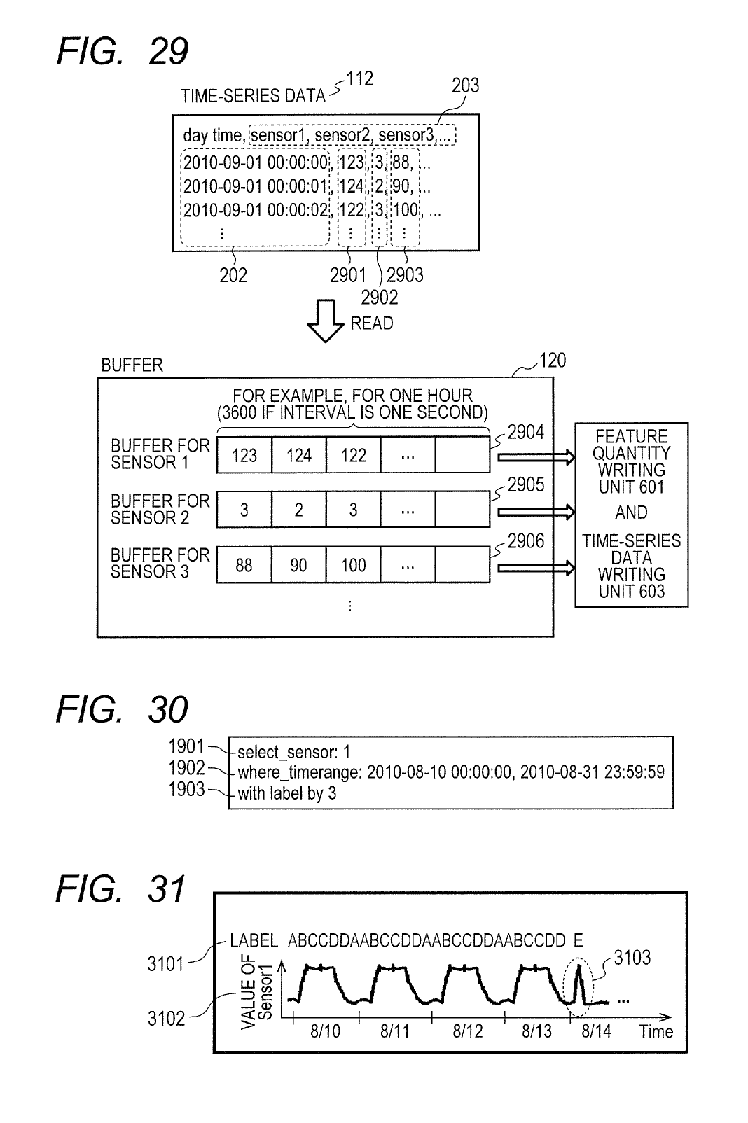

Next, the processing of the time-series data and the accumulation of the feature quantity will be described below. FIG. 7 is a flow chart illustrating the processing of the time-series writing unit 603 in the time-series data accumulation program 110. The processing is carried out with the input of the time-series data 112 from the administrator PC 103. First, the input time-series data 112 is stored in the buffer 120 according to the input type and is read (S701). FIG. 29 illustrates the situation in which the time-series data 112 described in FIG. 2 is read in S701. At the time of reading the time-series data 112, sensor values 2901 to 2903 are read according to the generation time and are stored in buffers 2904 to 2906 for each sensor, respectively. Further, with the sensor values stored in the buffers 2904 to 2906, the time-series data is divided for each time according to the time-series data division time width set in the buffers 2904 to 2906 for each sensor (S702).

For example, in the case of FIG. 29, the division is carried out at a time width of one hour. In this case, when the sensor value is continued at an interval of 1 second, 3,600 data are included in a divided predetermined time. Further, the time-series data dividedly stored in the buffer 120 are read and stored in the time-series data table 117 (S703). In this case, it is also possible to reduce the data quantity by compressing the divided data. In addition, FIG. 7 illustrates that the time-series data divided in S702 is stored in the time-series data table 117, but the time-series writing unit 603 can also acquire the time-series data 112 without using the buffers 2904 to 2906 and store the acquired time-series data in the time-series data table 117.

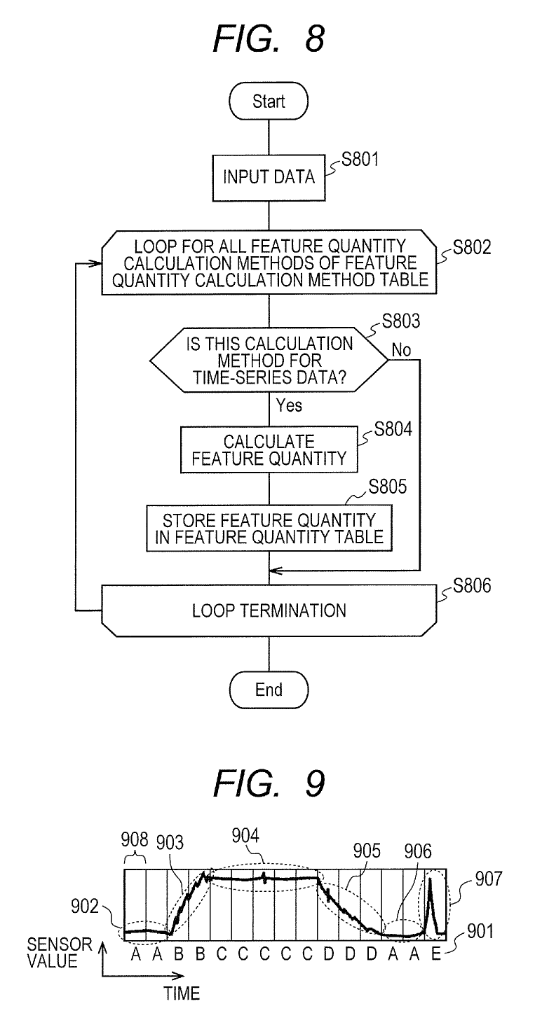

FIG. 8 is a flow chart illustrating the processing of the feature quantity writing unit 601 in the time-series data accumulation program 110. The processing is carried out with the input of the time-series data 112 from the administrator PC 103 and the feature quantity of the time-series data divided for each predetermined time by the processing of the time-series writing unit 603 and stored in the buffers 2904 to 2906 is calculated with referring to the feature quantity calculation method table 115 and is stored in the feature quantity table 116 (S802 to S806). In detail, the time-series data stored in the buffers 2904 to 2906 are read (S801) and all the feature quantity calculation methods of the feature quantity calculation method table 115 will be subjected to the following processing (S802). When the calculation method is not the calculation method for the time-series data (S803), the process proceeds to a loop termination (S806). When the calculation method is the method for calculating the feature quantity of the time-series data (S803), the feature quantity is calculated using the calculation method (S804). Further, the starting time, the ending time, the used calculation method ID, and the calculated feature quantity of the used time-series data are stored in the feature quantity table 116 (S805). Here, in S803, when the calculation method is not the feature quantity calculation method for the time-series data, the calculation method is the calculation method used in the additional feature quantity writing unit and herein, the feature quantity calculation using the calculation method is not carried out. In FIG. 5, the feature quantity calculation methods of which the feature quantity calculation method IDs are 1 to 4 (502 to 505) are the calculation method using the time-series data and the feature quantity calculation methods of which the feature quantity calculation method IDs are 5 and 6 (506 and 507) are the calculation method not using the time-series data (used in the additional feature quantity writing unit). In addition, the processing of the additional feature quantity writing unit 602 will be described below.

Further, in the example, the processing of dividing and storing the time-series data in the buffer 120 is described as the processings S701 and S702 carried out by the time-series writing unit 603, but the feature quantity writing unit 601 may also be carried out prior to the data input (S801) with the input of the time-series data 112 from the administrator PC 103.

As an example of the feature quantity calculation performed by the feature quantity writing unit 601, an example of allocating the label by the pattern will be described using the time-series data of FIG. 9. Herein, the feature quantity calculation method 3 (504) of the feature quantity calculation method table illustrated in FIG. 5 is used. FIG. 9 illustrates an example of the time-series data, which is a time-series data of a temperature sensor of an engine repeating starting and stopping every day. A vertical axis represents a temperature that is a sensor value and a horizontal axis represents a time. At the time of stopping the engine, the temperature of the engine is low and stable (902 and 906), during the starting of the engine, the temperature of the engine is changed and increased (903), when the starting of the engine ends, the temperature of the engine is high and stable (904), and during the stopping of the engine, the temperature of the engine is changed and reduced (905). The rightmost side 907 of the time-series data shows the abnormality such as the failure of the starting and shows that the temperature is increased once but falls immediately. An alphabet 901 shown in the lower part of the time-series data is an example of the label of the feature quantity calculated by using the feature quantity calculation method 3 (504) of the feature quantity calculation method table illustrated in FIG. 5. At the time of allocating the label, as illustrated in the alphabet 901 shown in the lower part of the time-series data, the individual label is allocated according to the patterns of the time-series data, respectively, such as A indicating the stopping in data 902 and 906 of which the temperature is low and stable, B indicating the increasing in the engine in data 903 of which the temperature is increased, C indicating the starting stable state in data 904 of which the temperature is high and stable, D indicating the stopping processing in data 905 of which the temperature falls, and E indicating the abnormality in data 907 of which the temperature is increased once and falls immediately.

As such, the label allocation is for the purpose of the high-speed search of the similar time-series pattern and allocates the same label 901 to a portion at which the patterns of the time-series data are similar to each other. Further, the search such as indicating the top 10 cases among the similar time-series patterns may also be carried out quickly by writing the similarity as the value of the feature quantity.

In the feature quantity calculation method 3 (504) illustrated in FIG. 5, the time-series data is divided into a fixed length 908 as illustrated in FIG. 9, and then clustering is carried out based on the time-series data within the divided section, and the label having one meaning is added to the clusters, respectively. The clustering is carried out based on three aspects of a gradient of data within a section, an average of data, and a distance between a regression line and a point taking a maximum value and a minimum value. FIG. 28 illustrates a flow chart of the feature quantity calculation method 3. When the feature quantity of the time-series data in any section is calculated by the feature quantity calculation method 3 (504), the calculation of the value required for the clustering is first carried out (S2802). In addition, the included cluster is set as a label 405 of the feature quantity by calculating in which cluster the section is included (S2803). Further, the value 406 of the feature quantity is stored as the similarity by calculating the distance (Euclidean distance) between the point indicating the section and the center of the included cluster (S2804). In addition to this, in step S2802 of the flow chart of FIG. 28, the number or sequence of the maximum value and the minimum value is additionally calculated and the clustering may be carried out in consideration thereof to indicate the pattern. Similarly, in the S2802 of the flow chart of FIG. 28, instead of calculating the gradient, the average value, and the distance, a method of using each value within the section as each axis so as to be mapped as a vector of a multi-dimensional space and carrying out the clustering may also be considered. Further, a fast Fourier transform, and the like, not the clustering, may also be considered.

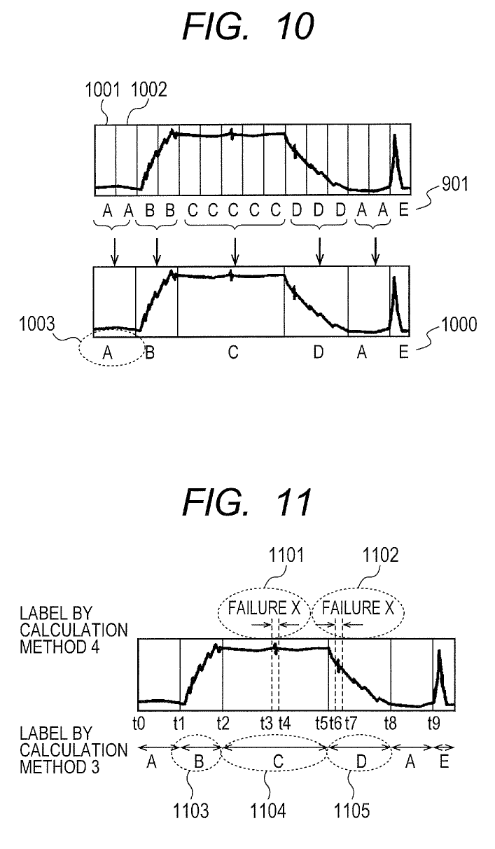

After the label is allocated, the section length of the feature quantity can also vary based on the label. The example is illustrated in FIG. 10. Further, a vertical axis represents a temperature that is a sensor value and a horizontal axis represents a time. In the example, when the same label is allocated to the adjacent sections, the section is integrated. For example, a first section 1001 and a second section 1002 from the left on FIG. 10 illustrating the label 901 allocated in FIG. 9 are allocated with a label A. Therefore, as illustrated in 1000 of FIG. 10, for example, the two sections are integrated so as to be set as one section and the integrated section is allocated with the label A (1003). As described above, the feature quantity table represents the section by the starting time and the ending time, and therefore the section need not be the fixed section. As such, the section in which the label is allocated is set as the varying length and is integrated, such that the size of the feature quantity table can be reduced. Further, the processing may be carried out at the time of storing the feature quantity table of the feature quantity writing unit 601 of FIG. 8 (S805), for example. When the label of the section during the processing is the same as the label of the just previous section, the ending time 402 of the just previous section is rewritten with the ending time of the section during the processing, such that the section during the processing and the just previous section may be integrated and stored into one section.

Further, like the label indicating the abnormality detection, a label having the small allocation frequency of a label may also be considered. In this case, the section length of the feature quantity varies based on a label, such that only data having a section allocated with the feature quantity is stored in the feature quantity table 116. By doing so, the size of the feature quantity table can be reduced. The example is a label 1101 and a label 1102 by the calculation method 4 (505) in FIG. 5 that is illustrated in an upper part of FIG. 11. In addition, a vertical axis represents a temperature that is a sensor value and a horizontal axis represents a time. In the case of the example, two abnormalities X that can be detected by the abnormality detection method A used in the calculation method 4 occur. The first starts at time t3 and ends time t4 and the second starts at time t6 and ends at time t7. Therefore, the label abnormality X is allocated at sections t3 and t4 and sections t6 and t7 by the calculation method 4. Further, there is no label allocated by the calculation method 4 in other sections, such that it is not stored in the feature quantity table. In the calculation method 4, the label is determined to be the abnormality X by any abnormality detection method A.

In addition, as the abnormality detection method, a rule base considered as the abnormality when a value like a spike of a value is increased and reduced within a predetermined time, anomaly considered as the abnormality when a value is not within a predetermined range, and the like may be considered, but the present invention is not limited thereto herein and any abnormality detection method can be used.

A part of the feature quantity table corresponding to the time-series pattern of FIG. 11 is illustrated in FIG. 4. For example, in FIG. 11, a label B is added by the calculation method 3 in the sections t1 to t2 (1103), which is represented like a row 409 in the feature quantity table of FIG. 4. Similarly, labels 1101, 1102, 1104, and 1105 of FIG. 11 are each represented by the rows 412, 413, 410, and 411 of FIG. 4. Herein, the value of the feature quantity has the similarity as a value for the row of the calculation method 3, as described above. For the calculation method 4, the abnormality degree defined by the abnormality detection method A is set as the value. For example, in the case of the anomaly abnormality detection method, a statistical method indicating how much the abnormality degree is out of the normal value, and the like, may be considered.

Next, the processing of the additional feature quantity writing unit 602 will be described below. The feature quantity writing unit 601 calculates and writes the feature quantity based on the time-series data with the input of the time-series data, while the additional feature quantity writing unit 602 is executed periodically or by an execution command from the administrator PC 103 to calculate and write a new feature quantity based on the feature quantity stored in the feature quantity table 116. The term “periodically” means in detail every time a specific time lapses or a specific amount of data is input or stored, and the like. The processing of the additional feature quantity writing unit 602 may be fetched at the last of the feature quantity writing unit 601. The processing of the additional feature quantity writing unit 602 may be divided into the feature quantity adding processing by the feature quantity calculation method, the feature quantity adding processing by the finding of the regularity, and the feature quantity adding processing by the non-similarity determination. All of the three processings may be carried out and some thereof may be carried out, when the additional feature quantity writing unit is executed.

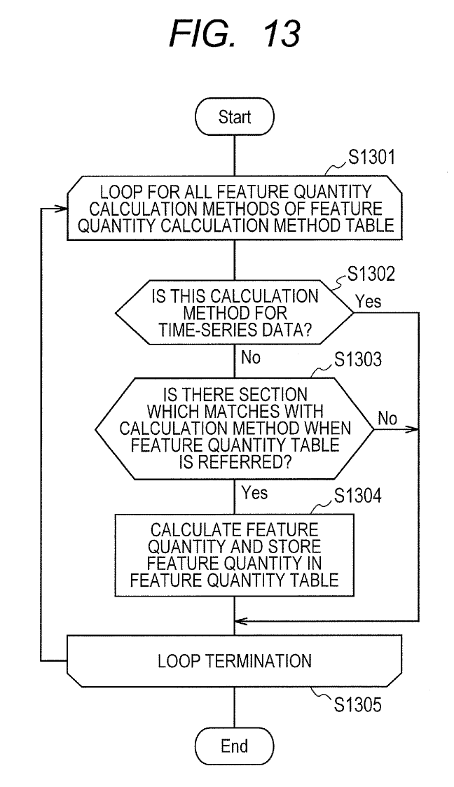

FIG. 13 is a flow chart illustrating the processing that adds the feature quantity in the feature quantity table 116 by allowing the additional feature quantity writing unit 602 to use a method for calculating a new feature quantity based on the feature quantity stored in the feature quantity table among the feature quantity calculation methods stored in the feature quantity calculation method table 115. In detail, all the feature quantity calculation methods of the feature quantity calculation method table 115 is looped from S1301 to S1305 and carried out. When the processing starts (S1301), it is determined whether the calculation method is a calculation method for the time-series data (S1302). The meaning that the method is not the calculation method for the time-series data represents the same as the calculation method for taking a branch of No to step S803 of FIG. 8. That is, the feature quantity calculation method is a calculation method that does not use the time-series data and the calculation methods 5 and 6 (506 and 507) in FIG. 5 correspond thereto. Further, when the calculation method is the calculation method for the time-series data, the process proceeds to the loop termination (S1305). When the calculation method is a calculation method for the feature quantity of the feature quantity table, not the calculation method for the time-series data, it is investigated whether there is a section matching the calculation method by referring to the feature quantity table (S1303). If there is a matched section, the label defined by the calculation method is calculated as a new additional label to add starting time and ending time of the section, a calculation method ID, a calculated feature quantity in the feature quantity table (S1304). If there is no matched section, the process proceeds to the loop termination (S1305).

The feature quantity adding processing by the feature quantity calculation method newly generates the feature quantity in, for example, a division unit different from the case of inputting the tie-series data or can newly reallocate the feature quantity by a feature quantity calculation method, which is not set at the time of the input of the time-series data.

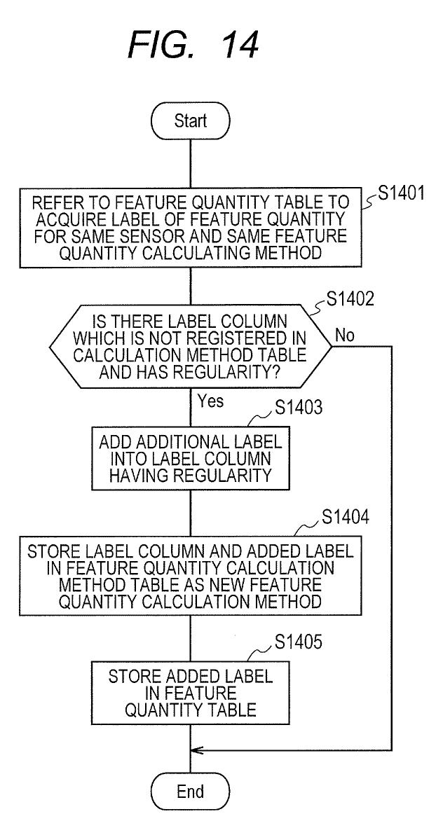

FIG. 14 is a flow chart illustrating that the additional feature quantity writing unit 602 carries out the feature quantity adding processing by the finding of the regularity. The processing adds a separate label by referring to the feature quantity table 116 when the same label column is plural. In detail, the same sensor ID 203 and the same feature quantity calculation method first refer to the feature quantity table 116 to extract the starting time, the ending time, and the label from the row in which the label is present as the feature quantity (S1401). Next, in S1402, these are sorted in the order of the starting time and are set as the label column. Further, it is determined whether a label column having regularity is present in the label column. When the same partial label column of a predetermined number or more is included in the label column, the label column having regularity is found. The partial label column means two or more continuous label columns included in any label column. When the label column having regularity cannot be found or the found label column is stored in the feature quantity calculation method table, the processing ends. Meanwhile, when the label column having non-registered regularity is found in the feature quantity calculation method table, a new separate label is allocated to the label column having regularity (S1403). Further, a new feature quantity calculation method allocating the new label from the label column having regularity is stored in the feature quantity calculation method (S1404). In addition, for all the label columns having regularity, the starting time of the first label as a starting time, the ending time of the last label as an ending time, a newly added feature quantity calculation method ID, and a new label in each repetitive unit of the label column having regularity are stored in the feature quantity table (S1405).

FIG. 16 illustrates an example of a new feature quantity allocated to the label column having regularity in the feature quantity adding processing by the finding of regularity. In FIG. 16, the label is ABCDABCDABCDABD in sequence from the left (old time side) and the partial label columns ABCD are regularly shown (1602). This shows that for example, the starting of the engine, and the repetition of the ending, and the like are periodically shown. Therefore, a new label F 1603 is added to the label column ABCD. In addition, the feature quantity calculation method “when the label columns ABCD are present, the label F is added in the section” is added in the feature quantity calculation method table (506 of FIG. 5). When the feature quantity calculation method ID is an ID that does not overlap another feature quantity calculation method in the feature quantity calculation method table, the time-series data processing device may designate and a system of managing a table, which is not illustrated in the drawing, may determine the feature quantity calculation method ID. In addition, a row “the starting time 401 is t0, the ending time 402 is t8, the sensor ID 203 is 1, the feature quantity calculation method ID 404 is 5, and the label 405 of the feature quantity is F” is added in the feature quantity table. Similarly, another section having the label columns ABCD is added in the feature quantity table.

Like label B1601, the section including the label B that is not included in the label F may be searched by adding a new label F. That is, the similar abnormality search can be efficiently carried out at the time of the abnormality finding by searching the label B that is not included in the label F indicating the normal repetition. The search processing will be described below.

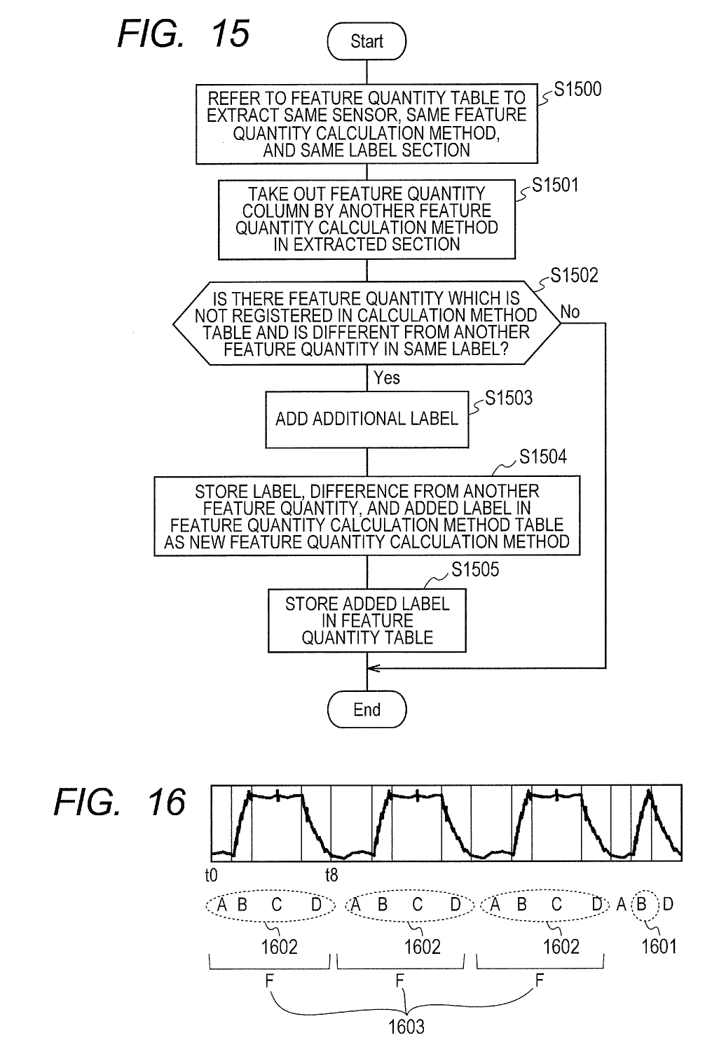

FIG. 15 is a flow chart illustrating that the feature quantity adding processing by the non-similarity determination carried out by the additional feature quantity writing unit 602. The processing adds the separate label by referring to the feature quantity table 116 when there is a difference in appearance frequency of the feature quantity for the separate feature quantity calculation method in a section having the same feature quantity for any feature quantity calculation method. Further, the difference in appearance frequency also includes the case whether the feature quantity is included or not (whether the appearance frequency is 1 or 0). In detail, the section in which the sensor ID 203, the feature quantity calculation method ID 404, and the feature quantity 407 is the same is first extracted by referring to the feature quantity table 116 (S1500) and for the extracted section, the feature quantity column having another feature quantity calculation method ID 404 is acquired (S1501). In addition, it is investigated whether for the acquired feature quantity column, the section having the difference in another feature quantity is present in a section in which the same label is allocated (S1502). If there is a section having a difference and the section is non-registered in the feature quantity calculation method table, a new label is added in the section (S1503). Further, a new feature quantity calculation method for adding a new label from a feature quantity having a difference in another feature quantity in the section in which the same label is allocated is stored in the feature quantity calculation method table (S1504). In addition, for the section having a difference, a new label is stored in the feature quantity table as a feature quantity (S1505).

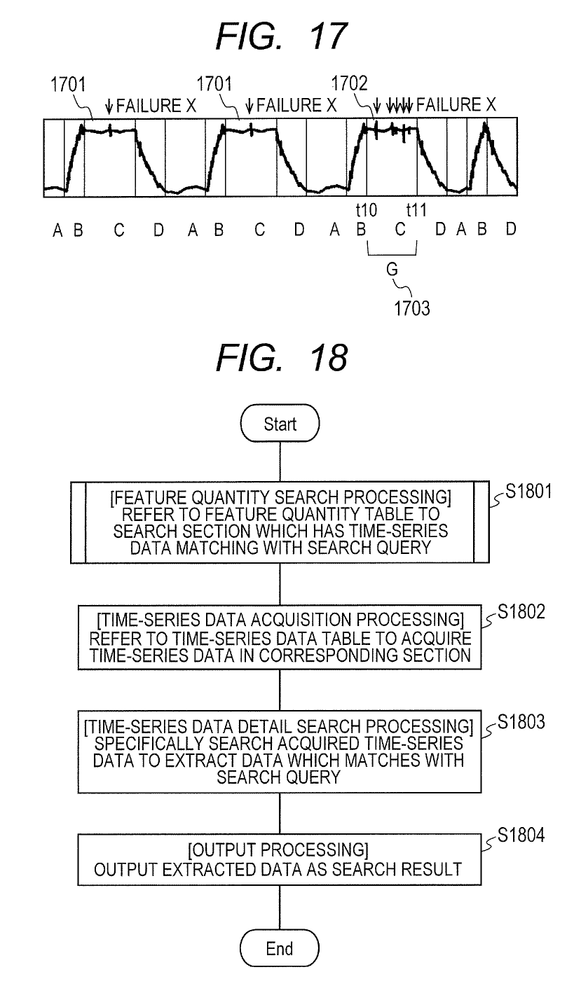

FIG. 17 illustrates an example of a new feature quantity allocated in the feature quantity adding processing by the non-similarity determination described in FIG. 15. In FIG. 17, it is considered that the number of abnormalities X is compared for the section in which the same label C is allocated. In FIG. 17, the abnormality X is shown as a point, but is actually a short section as illustrated in FIG. 11. In FIG. 17, the number of sections allocated with the label C is three and among the sections, for two sections 1701 of the left and the center, the number of abnormalities X is small as 1. Further, even for the section that is not illustrated, the number of abnormalities X within the section allocated with the label C is only 1. However, the right section 1702 allocated with the label C has the number of abnormalities X of 5 and is different from the section allocated with another label C. For this reason, unlike the section allocated with the same label C but having the different number of abnormalities X, a new label G 1703 is added in many sections 1702. This adds the feature quantity calculation method (row 507 of FIG. 5) in, for example, the feature quantity calculation table “when a section of the label C includes five abnormalities X or more, a label G is added in the section”.

Similar to the case of the finding of regularity, when the feature quantity calculation method ID 404 is an ID that does not overlap another feature quantity calculation method ID 404 present in the feature quantity calculation method table 508, the time-series data processing device may designate or the system of managing a table (not illustrated) may determine the feature quantity calculation method ID 404. Further, a row “the starting time 401 is t10, the ending time 402 is t11, the sensor ID 203 is 1, the feature quantity calculation method ID 404 is 6, and the label 405 of the feature quantity is G” is added in the feature quantity table. In addition to this, when there is the section of the label C including five or more abnormalities X, these sections are similarly added in the feature quantity table. In addition, the example is based on that the number of abnormalities X is 5, but the determination may be made based on the number of abnormalities X other than 5.

As the detection of the difference and the method for determining a threshold value of 5 or more, a method for using the statistical method in addition to average and dispersion, and the like, and the method for carrying out clustering may be considered. For example, in the case of using the statistical method, it can be considered that an average and a dispersion of the number of abnormalities X included in the section of the label C are obtained, and the case of “(average−3*standard deviation) or less or (average+3*standard deviation) or more”, and the like is determined as the non-similarity. As such, the threshold value is not limited to one threshold value like “5 or more” and two or more value such as “10 or less or 100 or more” may be set as threshold values. Further, in the embodiment, 5 is set as a threshold value, but another value may be set as a threshold value.

As the new label G is added, the section different from other sections may be searched even in the section in which the same label C is allocated. That is, it is possible to carry out a high-speed search in the normal state section during the starting in which the abnormalities X frequently occur.

By the aforementioned feature quantity additional processing by the additional feature quantity writing unit 602, the search can be carried out in real time so as to match the user request as the feature quantity table is updated by allocating the feature quantity which is not allocated when the time-series data are input. Further, the feature quantity is newly allocated based on the relationship of the plurality of feature quantities, such that an efficient search corresponding to composite search conditions can be carried out.

Next, the search processing will be described below. FIG. 18 is a flow chart illustrating processing of the time-series data search program 111. In this processing, the time-series data matching the search query 113 received from the client PC 104 are extracted and output as the search result 114. First, the feature quantity search unit 604 carries out the feature quantity search processing that narrows the section having the time-series data matching the search query 113 by referring to the feature quantity table 116 based on the received search query 113 (S1801). Further, the time-series data in the section narrowed in S1801 are transferred to the time-series data acquisition unit 605. The time-series data acquisition unit 605 acquires the time-series data in the transferred section from the time-series data table 117 and carries out the time-series data acquisition processing transferring the acquired time-series data to the time-series data detailed search unit 606 (S1802). The time-series data detailed search unit 606 carries out the time-series data detailed search processing that searches in detail the time-series data based on the transferred time-series data and the search query 113, extracts the data matching the search query, and transfers the extracted data to the output unit 607 (S1803). In addition, the output unit 607 carries out the output processing that outputs the transferred data as the search result (S1804).

The feature quantity search processing searches the section matching the search query using the feature quantity, whereas the time-series data detailed search unit searches the section matching the search query using the time-series data (raw data). The time-series data detailed search processing can search the section matching the search query using the time-series data in all the sections, but need to carry out the acquisition and search of a large quantity of time-series data, such that the search performance is degraded. The data quantity handled by the time-series data detailed search processing is efficiently narrowed by the feature quantity search processing, such that the search can be carried out quickly. The detailed search method is not particularly limited, but a method of calculating the similarity using, for example, the Euclidian distance or the time-warping distance and setting the upper k case (k is a natural number) or the similarity within the threshold value may be considered.

The feature quantity search unit 604 narrows the section likely to match the search query among all the time-series data to be searched using the feature quantity table. As a result, the acquisition of the time-series data and the data quantity to be searched in detail, which are post-processing, can be reduced. When a large quantity of time-series data to be searched is present, the data quantity to be acquired and searched in detail may be remarkably reduced by allocating the feature quantity according to the present invention, thereby quickly carrying out the search.

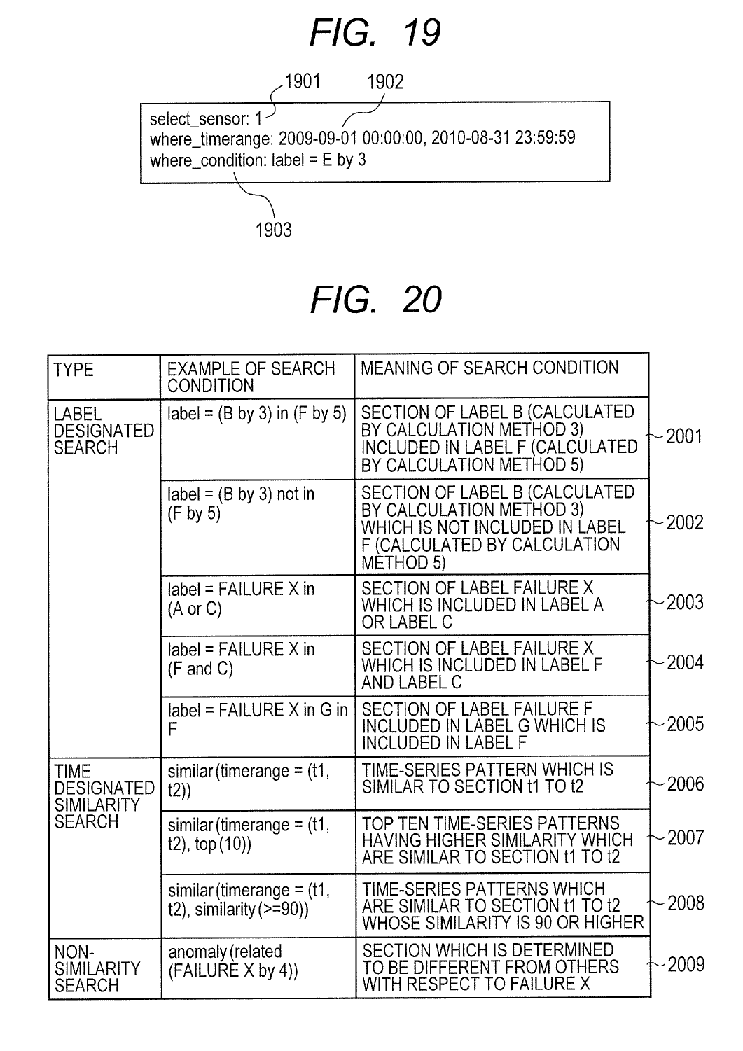

FIG. 19 illustrates an example of the search query 113. The search object sensor is designated with a select_sensor phrase 1901, the search object section of the time-series data is designated with a where_timerange phrase 1902, and the search conditions such as the feature quantity calculation method 115 and the feature quantity 407 are designated with a where_condition phrase 1903. In FIG. 19, for the time-series data on Sep. 1, 2009 to Aug. 31, 2010 of the sensor 1 as the object, the section allocated with the label E calculated by the feature quantity calculation method 3 is searched. Further, the description format of the search query illustrated in FIG. 19 is an example and is not limited thereto so long as any format may represent the same meaning.

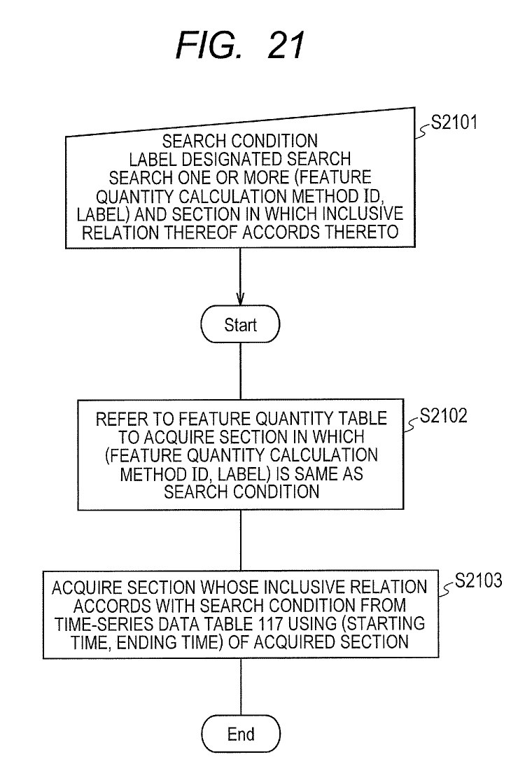

FIG. 20 illustrates some of examples of search conditions designated with where_condition phrase 1903 among the search queries. Herein, there are three types of search conditions, which are a “label designation search” (2001 to 2005) searching the designated feature quantity calculation method and a section allocated with the label, a “time designation similar search” (2006 to 2008) searching a section similar to the time-series pattern of the designated section, and a “non-similar search” 2009 searching a section considered as abnormality different from others in relation to the designated label. In the label designation search, in addition to designating 1903 one label such as the search conditions, the inclusive relation in which the search condition is included or not included in the separate label may also be designated (2001, 2002). In the time designation similar search, the time-series pattern similar to the designated section is searched (2006). In this case, one 2007 having the high similarity or one 2008 having similarity of a predetermined value or more may return as a result by calculating the similarity, by the value by the calculation method, the similarity of a group of labels allocated to the section, or the like. A method for setting a distance from a center of a cluster belonging to the clustering sets similarity or an Euclidian distance between patterns or the time-warping distance is set as similarity The non-similar search searches the section which is determined to be different from others in the additional feature quantity writing unit by the non-similarity determination and to which the label is added (2009). Next, the feature quantity search processing carried out by the feature quantity search unit 604 under each search condition will be described in detail with reference to a flow chart (FIGS. 21 to 23).

FIG. 21 is a flow chart of feature quantity search processing S1801 when the label designation search 2101 is given as the search condition. In the label designation search, a pair at least one feature quantity calculation method ID and a label and the inclusive relationship are designated using the description format, and the like, illustrated in FIG. 20. The feature quantity search unit 604 receiving the search query as an input using them as the search condition first refers to the feature quantity table 116 to have which one of the search conditions inputting the (feature quantity calculation method ID, label) acquire the same section (S2102). Further, the time-series data in the section in which the inclusive relationship matches the search conditions are acquired from the time-series data table 117 by using starting time and ending time of the acquired section (S2103).

FIG. 24 is a diagram illustrating an example of search by the label of the time-series data. In the example of FIG. 24, the case in which a user considers that the time-series data patterns in the section of 2402 is abnormal and searches the same time-series data patterns is considered. In the time-series pattern, the user recognizes that the label E 2401 is allocated and searches a section in which the label E is allocated. Herein, as the search condition 2101, “(calculation method 3, label E), no inclusive relationship is designated and the search is carried out. When the description method exemplified in FIGS. 19 and 20 is used, “label=E by 3” is described in the where_condition phrase. Then, in S2102, the sections t3 and t4 (2404) in which a label E2403 is allocated can be acquired. In this case, no designation of the inclusive relationship is present, and therefore in S2103, all the acquired sections are used as the search result and are transferred to the time-series data acquisition unit 605.

Herein, the user may determine that the label E is allocated to the section of 2402 by issuing the search query as illustrated in FIG. 30 based on the past data accumulated in, for example, the time-series data table 117. In this search query, a row “with label by 3” (3001) along with the search object sensor 1901 and the search object section 1902 illustrated in FIG. 19 is included, such that the label is acquired by the calculation method 3, along with the designated sensor and the time-series data in the time width. An example of a result display screen of the search query is illustrated in FIG. 31. The sensor designated below and the time-series data in the section are displayed as a graph (3102) and a section by the calculation method 3 is displayed on the corresponding section at the upper part thereof (3101). The user can appreciate that the label of the time-series pattern 3103 is E by seeing the screen, and therefore the similar search based on the label may be carried out. Further, the feature quantity calculation method table is directly managed by a user, and therefore the user previously recognizes which calculation method 3 is used.

Further, an example of the case in which the inclusive relationship is present will be described with reference to FIG. 16. The case of searching the label B not included in the label F, which is a general repetition, is considered. Herein, as the search condition 2101, “((calculation method 3, label B), (calculation method 5, label F)), B not in F” is designated and the search is carried out. “label=(B by 3) not in (F by 5)” is described in the where_condition phrase by using the description method exemplified in FIGS. 19 and 20. Then, in S2102, it is possible to acquire four sections in which the label B is allocated and three sections in which the label F is allocated. In S2103, the section of the label B satisfying the inclusive relationship, that is, “even for any label F, a label B not satisfying ((starting time of label F<=starting time of label B) and (ending time of label B<=ending time of label F))” is obtained. As a result, the section 1601 of the label B at the rightmost of FIG. 16 is transferred to the time-series data acquisition unit 605 as a search result.

By the processing, the similar time-series pattern search at the time of finding the abnormality or the context aware search in consideration of the relationship between the labels may be carried out quickly. Herein, the context aware search means the search of the time-series patterns that are generated based on the specific state (or based on the state other than the specific state) that is shown as the time-series data pattern. For example, there is a search for fluctuation in a normal state other than the transient state (during starting, during stopping, and the like) of a machine, and the like. Further, in an example of FIG. 16 as described above, the label B included other than the periodic fluctuation in the normal state in which the label F is allocated may also be searched by the processing.

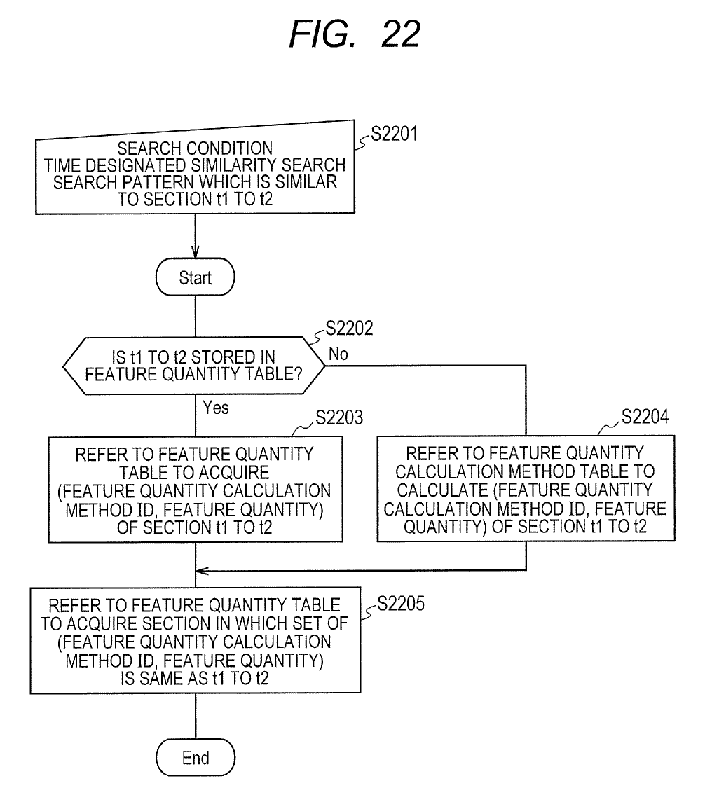

FIG. 22 is a flow chart of the feature quantity search processing S1801 when the time designation similar search 2201 is given as the search condition 1903 in the search query. In the time designation similar search, the starting time t1 and the ending time t2 designating the section are designated as an input. In this processing, the section having the feature quantity similar to the feature quantity in the sections t1 to t2 is searched using the feature quantity table 116. First, the feature quantity of the given sections t1 to t2 is obtained. When the sections t1 to t2 are previously stored in the feature quantity table 116 (S2202), the (feature quantity calculation method ID, feature quantity) in the sections t1 to t2 are acquired by referring to the feature quantity table 116 (S2203). Further, the feature quantity of the section including the sections t1 to t2 or the section included by the sections t1 to t2 may be acquired. On the other hand, when the sections t1 to t2 is not stored in the feature quantity table 116, similar to 610 of FIG. 12, the time-series data 112 in the sections t1 to t2 is read from the time series data table, and similar to the processing of the feature quantity calculation of the feature quantity writing unit, the (feature quantity calculation method ID, feature quantity) of the sections t1 to t2 are calculated by referring to the feature quantity calculation method table 115 (S2204). Similar to the foregoing, the feature quantity of the section including the sections t1 to t2 or the section included by the sections t1 to t2 may be calculated if possible. Next, the section in which the (feature quantity calculation method ID, feature quantity) acquired or calculated by referring to the feature quantity table or a combination thereof are the same is acquired (S2205). When the feature quantity allocated to the sections t1 to t2 is plural, the time-series data similar to the sections t1 to t2 may be searched by acquiring a section in which all or most of feature quantities coincide with each other.

The example of the similar search by the time designation will be described with reference to FIG. 24. As described above, the user considers that the time-series data patterns in the sections t1 to t2 are abnormal, and thus searches the same time-series data patterns. The user designates “similar to sections t1 to t2 (2402)” as the search condition 2201 and carries out a search. In the above S2202 to S2204, as the feature quantity of the sections t1 to t2 (2402), the (calculation method 3, label E) is acquired. In S2505, the sections t3 and t4 (2404) in which a label E 2403 is allocated can be acquired.

Through the processing, the search of the similar time-series patterns at the time of finding the abnormality may be carried out quickly. The processing is similar to the above label designation search, but the user designates the section in which the label is not present, and the feature quantity search unit acquires or calculates the label. Therefore, the user need not recognize the label and may carry out designation by more intuition.

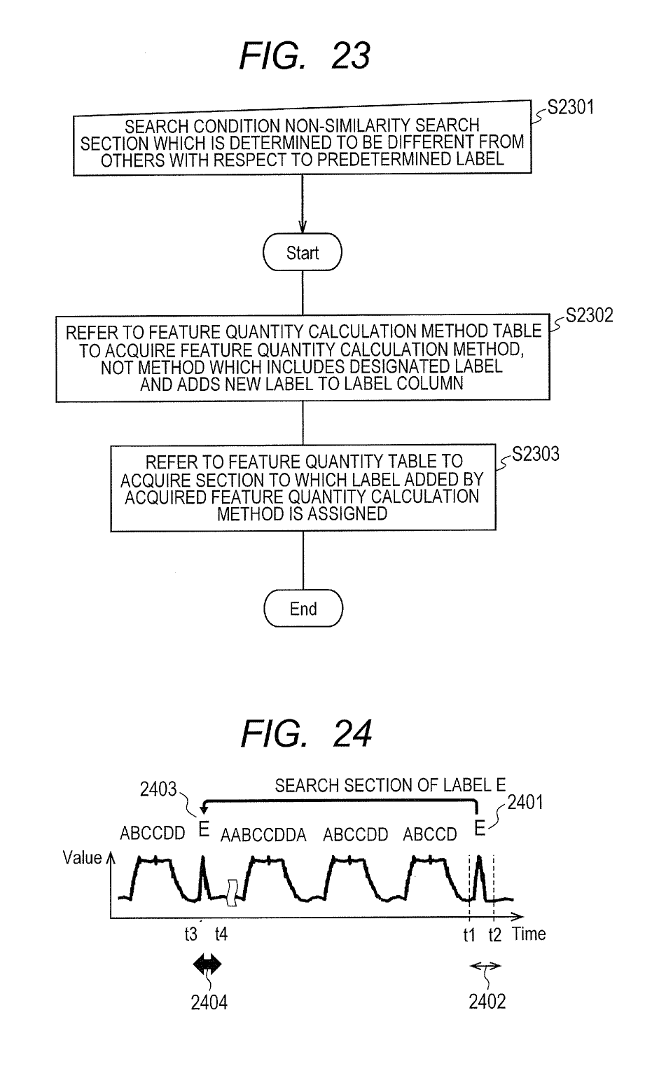

FIG. 23 is a flow chart of feature quantity search processing S1801 when the non-similar search 2301 is given as the search condition. In the non-similar search, the label is designated as an input and the section determined to be different from others in relation to the designated label is searched. First, the feature quantity calculation method in relation to the designated label is acquired by referring to the feature quantity calculation method table (S2302). That is, among the calculation methods that are stored in the feature quantity calculation method table, calculation method including the designated label but excepting for the calculation method for adding a new label to the label column is acquired. Further, the section allocated with the label added by the acquired feature quantity calculation method is acquired by referring to the feature quantity table (S2303).

By the processing, the non-similar search in relation to any label may be carried out quickly and may be used for the abnormality detection, and the like, at the time of monitoring the facilities. In the example of FIG. 17, when the non-similar search in relation to the label abnormality X is carried out, the section allocated with the label G may be obtained as the search result and the section having more abnormalities X than others may be obtained.

Hereinafter, the updating processing of the feature quantity table by the input from the user will be described. In using the system, the user may intend to review, verify, and change the calculation method for the feature quantity in a trial and error manner while analyzing the raw data. For this reason, there is a need to consider rewriting the allocated and written feature quantity table by changing the conditions or adding or deleting the feature quantity. The user inputs the feature quantity table updating command and the feature quantity writing unit 601 in the time-series data accumulation program 110 carries out the updating processing. As the feature quantity table updating command, there are, for example, a “rebuilding command” that recreates the feature quantity table from the time-series data table by deleting all the feature quantity tables, a “feature quantity calculation method adding and deleting command” that newly adds and deletes the calculation method to and from the feature quantity calculation method table, and the like.

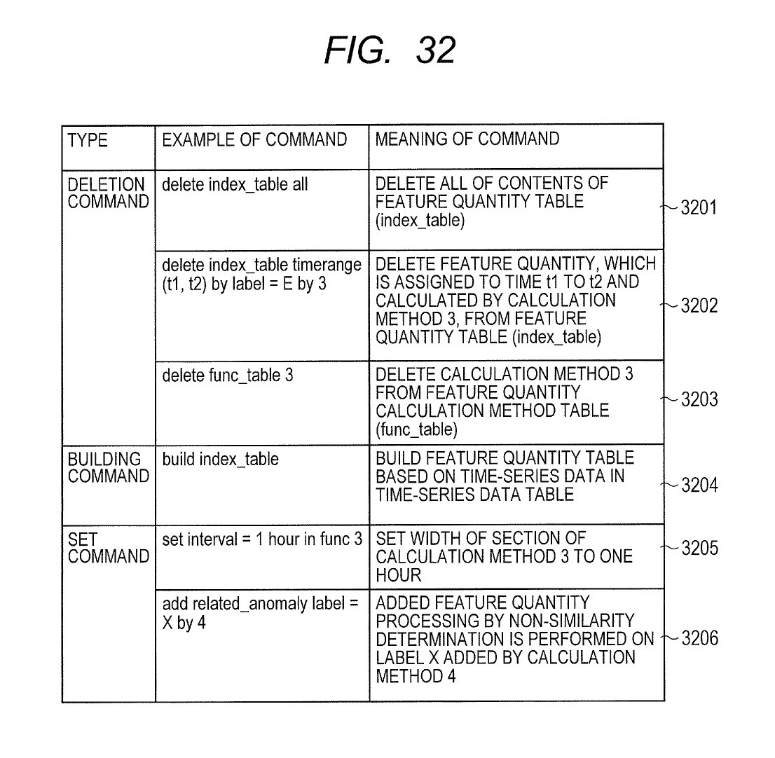

FIG. 32 illustrates an example of the feature quantity table updating command input from the user. Herein, the example of the command line is illustrated, but a graphic user interface (GUI) carrying out the same processing may be provided. As the command, there are deleting commands 3201 to 3203 that delete items within the table, a building command 3204 that builds the table, and setting commands 3205 and 3206 that sets parameters, and the like, for calculating the feature quantity, and the like. The deleting command 3201 deletes all the items within the feature quantity table. This command may be used in a combination with the building command 3204, for example, when rebuilding the feature quantity table.

The deleting command 3202 deletes a part of the feature quantities from the feature quantity table. For example, the time width, the calculation method, or the allocated feature quantity is designated and deleted. The deleting command 3203 deletes the calculation method 3 from the feature quantity calculation method table and at the same time, deletes the feature quantity about the calculation method 3 from the feature quantity table. The building command 3204 builds the feature quantity table based on the time-series data within the time-series table. This is used when intending to build the feature quantity table based on data within the time-series data table at the time of rebuilding or initializing the feature quantity table. As the setting command, the command 3205 setting the section width of the calculation method 3 or the command 3206 designating the feature quantity as an object in the additional feature quantity processing by the non-similarity determination may be considered. Further, a new command is defined by combining these commands or the command may be written according to each feature quantity calculation method. For example, the rebuilding of the feature quantity table may be defined by fetching the command 3201 and the command 3204 in sequence.

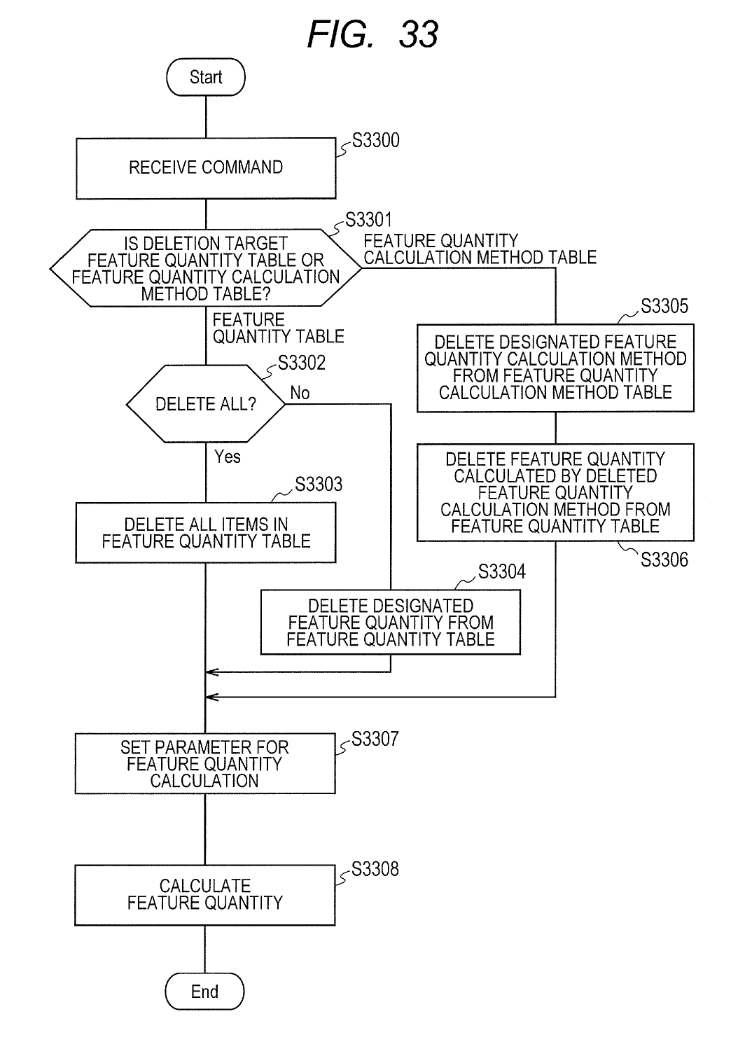

FIG. 33 is a flow chart illustrating an example of the feature quantity updating processing carried out by the feature quantity writing unit 601. First, the commands 3201 to 3206 are received (S3300) and the deletion processing is carried out according to the deleting commands 3201 to 3203. When the table to be deleted is the feature quantity table (S3301) and when all the items within the table are deleted (S3302), all the items are deleted from the feature quantity table (S3303). Further, when the table to be deleted is the feature quantity table (S3301) and when all the items are not deleted (S3302), the feature quantity designated by the command from the feature quantity table is deleted (S3304). Meanwhile, when the table to be deleted is the feature quantity calculation method table (S3301), the designated feature quantity calculation method is deleted from the feature quantity calculation method table by accessing the feature quantity calculation method table (S3305) and the feature quantity calculated by the feature quantity calculation method deleted from the feature quantity table is deleted by accessing the feature quantity table (S3306).

Next, parameters for calculating the feature quantity, and the like are reset by accessing the feature quantity calculation method table according to the setting commands 3205 and 3206 (S3307). Next, the building processing is carried out according to the building command 3204 to calculate the feature quantity (S3308). As described with reference to FIG. 12, in the building processing, the feature quantity writing unit 601 acquires the time-series data from the time-series data stored in the time-series data table 117 (610) and the feature quantity is calculated based on the time-series data to be stored in the feature quantity table. In this case, the processing carried out by the feature quantity writing unit 601 is the same as S802 to S806 of FIG. 8. When the feature quantity is stored in the feature quantity table, the updating processing of the feature quantity table ends.

As such, by carrying out the updating processing of the feature quantity table, the user reviews, verifies, and changes the calculation method of the feature quantity in a trial and error manner based on the analysis result of raw data, such that the user can more preferably realize the search for the time-series data.

Further, in the updating processing of the feature quantity table, the processing corresponding to the command included in the command received in S3300 among the deleting commands 3201 to 3203, the building command 3204, the setting commands 3205 and 3206, and the like may be carried out, and all of the deleting processings S3301 to S3306, the setting processing S3307, and the building processing S3308 are not necessarily carried out.

In addition, some options for the answer to the search query from the user may be considered during the updating processing of the feature quantity table. For example, there may be a case in which the search from the user may not be entirely accepted during the updating of the feature quantity table. When an answer is given based on the feature quantity table during the updating, the incomplete search result is likely to be returned.

Further, the detailed search is carried out by directly acquiring all the time-series data from the time-series data table without using the feature quantity, such that the availability may be more increased than the foregoing method.

In addition, the feature quantity updating processing unit informs to what extent the updating of the feature quantity table ends to the feature quantity search unit 604 using a message or a sharing memory, such that the feature quantity is used for the updated portion and all the time-series data are acquired for the non-updated portion, thereby more improving the performance than the foregoing method.

Further, in the use place where consistency is not particularly required, the search may be carried out using the feature quantity table during the updating.

In connection with whether or not to use any of these methods, the user or administrator may select the appropriate method for the place where the system is operated or used. In connection with the accumulation processing of the time-series data, there is no problem in simultaneously carrying out the methods in parallel, and therefore the methods may be carried out in parallel.

According to the abovementioned embodiments, in the time-series data processing device processing the time-series data continuously or discontinuously generated over time, at the time of accumulating the time-series data, the pattern in the section in which the time-series data are present is stored in the feature quantity table as a label. Therefore, at the time of searching the time-series data, the range of the acquisition of the time-series data and the detailed search is narrowed based on the feature quantity table, thereby promoting the high-speed search processing.

### REFERENCE SIGNS LIST

101 Time-series data processing device
102 Storage device
103 Administrator PC
104 Client PC
105 Memory
107 Processor
110 Time-series data accumulation program
111 Time-series data search program
112 Time-series data
113 Search query
114 Search result
115 Feature quantity calculation method table
116 Feature quantity table
117 Time-series data table
601 Feature quantity writing unit
602 Additional feature quantity writing unit
603 Time-series writing unit
604 Feature quantity search unit
605 Time-series data acquisition unit
606 Time-series data detailed search unit
607 Output unit

1. A data processing system including a data processing device, the data processing device comprising:
a storage device holding time-series data that are data generated over time and feature information that is information indicating a feature of the time-series data; and
a feature information generation unit that extracts a time-series data group from the time-series data, generates first feature information that is the feature information about a change in a data value for the time-series data group, and records the first feature information in the storage device, being associated with the time-series data in a unit of the time-series data group.

2. The data processing system according to claim 1, wherein the data processing device further includes a time-series data search unit that searches the time-series data held in the storage device based on the first feature information held in the storage device.

3. The data processing system according to claim 2, wherein the time-series data search unit receives information indicating a first time-series data group, generates the first feature information for the first time-series data group, extracts the first feature information similar to the first feature information about the first time-series data group from the storage device, and extracts as the search result the time-series data associated with the first feature information similar to the first feature information about the first time series data group from the storage device.

4. The data processing system according to claim 1, wherein the data processing device extracts a plurality of items of first feature information recorded in the storage device, generates second feature information that is the feature information based on the plurality of items of extracted first feature information, and records the second feature information in the storage device, to correspond to at least a part of the time-series data held in the storage device corresponding to the extracted first feature information.

5. The data processing system according to claim 4, wherein the storage device holds time-series data generation time information that is information about the time when the time-series data included in the time-series data group are generated, to correspond to the first feature information generated for the time-series data group, and the additional feature information generation unit extracts two or more items of the first feature information and the time-series data generation time information corresponding to the two or more items of the first feature information, from the storage device and generates the second feature information based on the two or more items of the first feature information and the time-series data generation time information extracted from the storage device.

6. The data processing system according to claim 5, wherein the additional feature information generation unit generates the second feature information based on a temporal sequence relationship of the two or more items of the first feature information extracted from the storage device and the time-series data generation time information corresponding to the two or more items of the first feature information extracted from the storage device, respectively.

7. The data processing system according to claim 4, wherein the feature information generation unit individually generates the first feature information for each of the two or more time-series data groups including the same time-series data and records the individually generated items of the first feature information in the storage device, respectively, and the additional feature information generation unit generates the second feature information for at least one of the two or more time-series data groups including the same time-series data based on the relationship between the individually generated items of the first feature information.

8. The data processing system according to claim 4, wherein the storage device holds a feature information generation method that is information indicating a method for allowing the feature information generation unit to generate the first feature information, and the additional feature information generation unit stores the information indicating a method of generating the second feature information in the storage device as the feature information generation method when generating the second feature information.

9. The data processing system according to claim 4, wherein the data processing device further includes a time-series data search unit that searches the time-series data held in the storage device based on at least one of the first feature information and the second feature information held in the storage device.

10. The data processing system according to claim 1, further comprising:
a measurement device connected with the data processing device through a network and transmitting the measured result to the data processing device as the time-series data.

11. A data processing system, comprising:
a storage device holding time-series data that are data generated over time and feature information that is information indicating a feature about a change in a data value of the time-series data; and
a data processing device that searches the time-series data held in the storage device based on the time-series data and the feature information held in the storage device in association with the time-series data.

12. A data processing device connected with a storage device, comprising:
a time-series data receiving unit receiving time-series data that are data generated over time; and
a feature information generation unit that extracts a time-series data group from the time-series data received by the time-series data receiving unit, generates first feature information that is information indicating a feature about a change of a data value for the time-series data group, and records the first feature information in the storage device, being associated with the time-series data in a unit of the time-series data group.

13. The data processing device according to claim 12, further comprising:
a time-series data search unit that searches the time-series data held in the storage device based on the first feature information held in the storage device.

14. The data processing device according to claim 13, wherein the time-series data search unit receives information indicating a first time-series data group, generates the first feature information for the first time-series data group, extracts the first feature information similar to the first feature information about the first time-series data group from the storage device, and extracts, as the search result, the time-series data associated with the first feature information similar to the first feature information about the first time series data group from the storage device holding the time-series data.

15. The data processing device according to claim 12, further comprising:
an additional feature information generation unit that extracts the first feature information recorded in the storage device, generates second feature information that is information indicating a feature about a change in a data value of at least a part of the time-series data corresponding to the extracted first feature information based on the extracted a plurality of items of the first feature information, and records the second feature information in the storage device, to correspond to at least a part of the time-series data held in the storage device to correspond to the extracted first feature information.

16. The data processing device according to claim 15, wherein the feature information generation unit records time-series data generation time information that is information about the time when the time-series data included in the time-series data group are generated and the first feature information generated for the time-series data group that correspond to each other in the storage device, and the additional feature information generation unit extracts two or more items of the first feature information and the time-series data generation time information corresponding to the two or more items of the first feature information, respectively, from the storage device and generates the second feature information based on the two or more items of the first feature information and the time-series data generation time information extracted from the storage device.

17. The data processing device according to claim 16, wherein the additional feature information generation unit generates the second feature information based on a temporal sequence relationship of the two or more items of the first feature information extracted from the storage device and the time-series data generation time information corresponding to the two or more items of the first feature information extracted from the storage device, respectively.

18. The data processing device according to claim 15, wherein the feature information generation unit individually generates the first feature information for each of the two or more time-series data groups including the same time-series data and records the individually generated items of the first feature information, respectively, in the storage device, and the additional feature information generation unit generates the second feature information for at least one of the two or more time-series data groups including the same time-series data based on the relationship between the individually generated items of the first feature information.

19. The data processing device according to claim 15, wherein the additional feature information generation unit generates the first feature information based on a feature information generation method that is information indicating a method of generating the first feature information held in the storage device and, stores the information indicating a method of generating the second feature information in the storage device as the feature information generation method when generating the second feature information.

20. The data processing device according to claim 15, further comprising:
a time-series data search unit that searches the time-series data held in the storage device based on at least one of the first feature information and the second feature information held in the storage device.
